(19) United States
(12) Patent Application Publication
(10) Pub. No.: US 2021/0148238 A1
(43) Pub. Date: May 20, 2021

(54) ANTI-CMAS COATING WITH DUAL REACTIVITY

(71) Applicant: SAFRAN, PARIS (FR)

(72) Inventors: Luc BIANCHI, MOISSY-CRAMAYEL (FR); Aurélien JOULIA, MOISSY-CRAMAYEL (FR); Benjamin Dominique Roger Joseph BERNARD, MOISSY-CRAMAYEL (FR)

(21) Appl. No.: 16/621,568

(22) PCT Filed: Jun. 11, 2018
(86) PCT No.: PCT/FR2018/051349

§ 371 Date: Dec. 11, 2019

(30) Foreign Application Priority Data
Jun. 12, 2017 (FR) 1755211

(51) Int. Cl. F01D 5/28; C04B 35/488; C04B 35/505; C04B 35/622; C23C 4/11

(52) U.S. Cl. CPC F01D 5/288; C04B 2235/5436; C04B 35/505; C04B 35/62222; C23C 4/11; F05D 2220/32; F05D 2240/30; F05D 2230/311; F05D 2230/312; F05D 2230/90; F05D 2300/17; C04B 2235/3248; C04B 2235/3427; C04B 2235/5454; C04B 2235/5445; C04B 35/488

(57) ABSTRACT

A coated gas turbine engine part includes a substrate and a calcium-magnesium-alumino-silicate (CMAS) protection layer present on the substrate. The protection layer includes a first phase of a calcium-magnesium-alumino-silicate CMAS protection material capable of forming an apatite or anorthite phase in the presence of calcium-magnesium-alumino-silicates CMAS and a second phase including particles of at least one rare-earth REa silicate dispersed in the first phase.

### BACKGROUND OF THE INVENTION

The present invention relates to the general field of protective coatings used to thermally insulate parts in high-temperature environments such as parts used in hot parts of aeronautical or land gas turbine engines.

In order to improve the efficiency of gas turbine engines, in particular high-pressure turbines (HPT) for stationary land-based systems or for aeronautical propulsion, increasingly higher temperatures are being considered. Under these conditions, the materials used, such as metallic alloys or ceramic matrix composites (CMC), require protection, mainly to maintain a sufficiently low surface temperature to ensure their functional integrity and limit their oxidation/corrosion by the surrounding atmosphere.

“Thermal barrier” (TB) or “environmental barrier coating” (EBC) protections are complex multilayer stacks generally consisting of a bond coat allowing protection against oxidation/corrosion deposited on the surface of the base material (metal alloys or composite material) of the substrate, itself topped by a ceramic coating whose primary function is to limit the surface temperature of the coated components. In order to ensure its protection function against oxidation/corrosion and to promote the adhesion of the ceramic coating, the bond coat is preoxidized to form a dense alumina layer on its surface called “thermally grown oxide” (TGO) in the case of thermal barriers. Such protection systems are described in particular in documents D. R. Clarke, M. Oechsner, N. P. Padture, “Thermal-barrier coatings for more efficient gas-turbine engines”, MRS Bulletin, 37, 2012, pp 892-898 and D. Zhu, R. A. Miller, “Thermal and Environmental Barrier Coatings for Advanced Propulsion Engine Systems”, NASA Technical Memorandum, 213129, 2004.

The service life of these systems (TB and EBC) depends on the resistance of the stack to thermal cycling, on the one hand, and on the resistance of the outer layer to environmental stresses (erosion by solid particles, chemical resistance, corrosion, etc.), on the other hand.

In particular, these systems degrade very quickly when exposed to a medium rich in sand or volcanic ash particles (rich in inorganic silica type compounds) commonly known by the generic name CMAS (for oxides of Calcium, Magnesium, Aluminium and Silicon). The infiltration of molten CMAS into a thermal or environmental barrier generally results in degradation by:
stiffening of the infiltrated layer leading to mechanical failure (delamination);
destabilization by chemical dissolution of the thermal barrier and formation of recrystallized products with different mechanical properties and/or volumes.

To overcome this problem, so-called “anti-CMAS” compositions have been developed, which allow the formation of a waterproof barrier layer by chemical reaction with CMAS as described in document C. G. Levi, J. W. Hutchinson, M. -H. Vidal-Sétif, C. A. Johnson, “Environmental degradation of thermal barrier coatings by molten deposits”, MRS Bulletin, 37, 2012, pp 932-941. The anti-CMAS compositions used will be dissolved in CMAS to form a dense protective phase with a higher melting point than CMAS. In the case of the family of rare-earth zirconates, very promising anti-CMAS materials, this dissolution allows the formation of an apatite phase of type Ca₂RE₈(SiO₄)₆O₂ (RE=rare earth) which will be blocking but also “parasitic” or secondary phases of the partially stabilized zirconia type (mainly in fluorite form), spinels, or even rare-earth silicates as described in the documents S. Kramer, J. Yang, C. G. Levi, “Infiltration-inhibiting reaction of gadolinium zirconate thermal barrier coatings with CMAS melts”, Journal of the American Ceramic Society, 91, 2008, pp 576-583 and H. Wang, “Reaction mechanism of CaO—MgO—Al₂O₃—SiO₂ (CMAS) on lanthanide zirconia thermal barrier coatings”, PHD Thesis, Auburn University, USA, 2016. However, these secondary phases have volumes and/or thermomechanical or mechanical properties that may reduce the beneficial effect of the anti-CMAS coating.

There is therefore a need for a gas turbine engine part with a CMAS protection layer that confines the CMAS reaction zone to the vicinity of the surface of the protective layer and limits the formation of secondary phases.

### Subject Matter and Summary of the Invention

The principal aim of the present invention is therefore to increase the reaction capacity or kinetics of a CMAS protection layer to form a layer or phase blocking liquid contaminants in order to limit their deep penetration into the coating by providing a coated gas turbine engine part comprising a substrate and at least one calcium-magnesium-alumino-silicate CMAS protection layer present on said substrate, the layer comprising a first phase of a calcium-magnesium-alumino-silicate CMAS protection material capable of forming an apatite or anorthite phase in the presence of calcium-magnesium-alumino-silicates CMAS and a second phase comprising particles of at least one rare-earth RE^{a} silicate dispersed in the first phase.

The addition of a rare-earth silicate phase in divided form in the first phase or matrix phase of the CMAS protection layer increases the reactivity of the latter in order to limit the capillary penetration depth of liquid CMAS within the porosity and/or vertical cracking network present in the layer. Indeed, rare-earth silicates are precursors of the protective apatite phase. The second phase is therefore an “activating” phase of the protective apatite phase. Consequently, the service life of the CMAS protection layer thus obtained is increased compared to that expected for the same protection layer without adding this second phase. In addition, the inclusion of particles of a rare-earth silicate in the base material of the CMAS protection layer allows, during the formation of the blocking phase, to limit the formation of secondary phases with mechanical properties that limit the protective effects of the layer.

According to a particular aspect of the invention, the rare-earth silicate used for the second phase of the protective layer is a rare-earth monosilicate RE^{a}₂SiO₅ or a rare-earth disilicate RE^{a}₂Si₂O₇, where RE^{a} is selected from: Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium).

According to another particular aspect of the invention, the rare-earth RE^{a} silicate particles dispersed in the CMAS protection layer have an average size between 5 nm and 50 μm, more preferentially between 5 nm and 1 μm.

According to another particular aspect of the invention, the CMAS protection layer has a volume content of particles of rare-earth silicate of between 1% and 80%.

According to another particular aspect of the invention, the volume percentage of rare-earth RE^{a} silicate ceramic particles present in the CMAS protection layer varies in the direction of the thickness of the protective layer, the volume percentage of rare-earth RE^{a} silicate ceramic particles gradually increasing between a first zone of said adjacent layer of the substrate and a second zone of said layer remote from the first zone.

According to another particular aspect of the invention, the CMAS protection layer has a thickness between 1 μm and 1000 μm.

According to another particular aspect of the invention, the calcium-magnesium-alumino-silicate CMAS protection material of the first phase capable of forming apatite or anorthite phases corresponds to one of the following materials or a mixture of several of the following materials: rare-earth zirconates RE^{b}₂Zr₂O₇, where RE^{b}=Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium), fully stabilized zirconia, delta phases A₄B₃O₁₂, where A=Y >Lu and B=Zr, Hf, composites Y₂O₃ with ZrO₂, yttrium and aluminium garnets (YAG), composites YSZ-Al₂O₃ or YSZ-Al₂O₃TiO₂.

According to another particular aspect of the invention, a thermal barrier layer is interposed between the substrate and the calcium-magnesium-alumino-silicate CMAS protection layer.

According to another particular aspect of the invention, the substrate is made of nickel or cobalt-based superalloy and has an alumino-forming bond layer on its surface.

The invention also relates to a process for manufacturing a gas turbine engine part according to the invention, comprising at least one step of forming a calcium-magnesium-alumino-silicate CMAS protection layer directly on the substrate or on a thermal barrier layer present on the substrate, the forming step being performed with one of the following processes:
suspension plasma spraying from a suspension containing a powder or precursor of a calcium-magnesium-alumino-silicate CMAS protection material and a powder or precursor of a rare-earth RE silicate or any combination thereof,
high-velocity flame spraying from a suspension containing a powder or precursor of a calcium-magnesium-alumino-silicate CMAS protection material and a powder or precursor of a rare-earth RE silicate or any combination thereof,
atmospheric-pressure plasma spraying of a powder of a calcium-magnesium-alumino-silicate CMAS protection material in combination with suspension plasma spraying or high-velocity flame spraying from a solution containing a rare-earth RE silicate ceramic precursor or a rare-earth RE silicate ceramic powder in suspension.

### BRIEF DESCRIPTION OF THE DRAWINGS

Other features and advantages of the present invention will emerge from the description given below, with reference to the appended drawings which illustrate exemplary embodiments without any restrictive character. On the figures:

FIGS. 1A and 1B show the infiltration of liquid contaminants into a calcium-magnesium-alumino-silicate CMAS protection layer according to the prior art,

FIGS. 2A and 2B show the infiltration of liquid contaminants into a calcium-magnesium-alumino-silicate CMAS protection layer according to the invention,

FIG. 3 is a first exemplary embodiment of a process for producing a gas turbine engine part according to the invention,

FIG. 4 is a second exemplary embodiment of a process for producing a gas turbine engine part according to the invention,

FIG. 5 is a third exemplary embodiment of a process for producing a gas turbine engine part according to the invention,

FIG. 6 is a fourth exemplary embodiment of a process for producing a gas turbine engine part according to the invention.

### DETAILED DESCRIPTION OF THE INVENTION

The invention applies generally to any gas turbine engine part coated with a protective layer comprising a phase of a calcium-magnesium-alumino-silicate CMAS protection material. “CMAS protection material” means all materials which prevent or reduce the infiltration of molten CMAS into the protective layer, in particular by the formation of at least one apatite or anorthite phase.

By way of non-limiting examples, the calcium-magnesium-alumino-silicate CMAS protection material likely to form apatite or anorthite phases corresponds to one of the following materials or a mixture of several of the following materials:
rare-earth zirconates RE^{b}₂Zr₂O₇, where RE^{b}=Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium),
fully stabilized zirconia,
the delta phases A₄B₃O₁₂, where A denotes any element selected from: Y, La, Ce, Pr, Nd, Pm, Sm, Eu, Gd, Tb, Dy, Ho, Er, Tm, Yb and Lu and B=Zr, Hf,
composites comprising Y₂O₃ with ZrO₂,
yttrium and aluminium garnets (YAG),
YSZ-Al₂O₃ or YSZ-Al₂O₃TiO₂ composites.

The invention applies more particularly to rare-earth zirconates RE^{b}₂Zr₂O₇, where RE^{b}=Y, La, Nd, Sm, Gd, Dy, Yb, delta phases with A=Y, Dy or Yb and composite Y₂O₃ZrO₂.

In accordance with the invention, to this first phase, which constitutes the matrix of the CMAS protection layer, is added a second phase in the form of particles of at least one rare-earth RE silicate dispersed in the protective layer whose matrix is formed by the first phase.

The inventors found that rare-earth monosilicates or disilicates are capable of reacting in the presence of CMAS to form an apatite phase, a blocking phase that limits the infiltration depth of liquid CMAS into the protective layer, without being dissolved in the liquid glass. The inventors have therefore determined that the addition in the form of a rare-earth monosilicate and/or disilicate filler dispersed in a CMAS protection material constitutes an “activating” phase for the formation of apatite phases. By thus exacerbating the reactivity of the CMAS protection material with fillers distributed in the CMAS protection material, it is possible to form blocking phases for liquid CMAS by using different reaction mechanisms, the formation of the blocking phases being generated independently between the CMAS protection material of the first phase and the rare-earth silicate particles of the second phase. This limits the infiltration of liquid CMAS into the volume of the material. Therefore, by limiting the depth of CMAS infiltration into the protective layer, changes in thermomechanical properties or volumes resulting from the formation of blocking phases, as well as secondary phases resulting from the dissolution of the CMAS protection material, are limited. The mechanical stresses at the core of the protective layer are also reduced, which increases the service life of the protection under operating conditions.

The particles dispersed in the matrix or first phase of the CMAS protection layer may consist of a RE^{a}₂SiO₅ rare-earth monosilicate or a RE^{a}₂Si₂O₇ rare-earth disilicate, where RE^{a} is selected from: Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium). More preferably, the rare earth RE^{a} of the rare-earth monosilicate RE^{a}₂SiO₅ or of the rare-earth disilicate RE^{a}₂Si₂O₇, is chosen from: La, Gd, Dy, Yb, Y, Sm, Nd.

The second “activating” phase for the formation of apatite phases present as particles dispersed in the CMAS protection layer can be obtained from powders, suspensions, precursors in solution or a combination of these different forms.

The rare-earth RE^{a} silicate particles dispersed in the first phase preferably have an average size between 5 nm and 50 μm and preferentially between 5 nm and 1 μm. In the present disclosure, the terms “between . . . and . . . ” are to be understood as including the boundaries.

The protective layer has a volume content of rare-earth silicate particles which can be between 1% and 80%, preferentially between 1% and 30%.

The protective layer may have a composition gradient wherein the volume percentage of the first phase of the anti-CMAS material and the second phase of rare-earth silicate particles changes with the thickness of the protective layer. More precisely, the volume percentage of rare-earth RE^{a} silicate ceramic particles present in the CMAS protection layer can vary with the thickness of the protective layer, the volume percentage of rare-earth RE^{a} silicate ceramic particles gradually increasing between a first zone of said layer adjacent to the substrate and a second zone of said layer remote from the first zone. By introducing such a gradient in the content of rare-earth RE^{a} silicate particles into the protective layer, the reactivity and the CMAS-resistance effect is favoured in the vicinity of the upper surface of the protective layer by a high concentration of rare-earth silicate at this location of said protection layer while preserving the thermomechanical resistance of the system by a lower concentration of rare-earth silicate in the protective layer near the substrate. Rare-earth silicate has a low coefficient of thermal expansion that can reduce the strength of the protective layer in the vicinity of the substrate, as the differences in coefficient of expansion between the rare-earth silicate and the substrate material are significant.

The protective layer preferably has a porous structure, which allows it to have good thermal insulation properties. The protective layer may also have vertical cracks, initially present in the layer or formed during use, which give the layer a higher deformation capacity and therefore a longer service life. The porous and cracked microstructure (initially or in use) of the protective layer is mainly obtained by controlling the forming (deposition) process of the layer as well known per se.

Thanks to the presence of a second “activating” phase in the protective layer allowing the formation of blocking phases for liquid CMAS in the vicinity of the layer surface, these porosities and cracks no longer constitute favoured paths for the infiltration of molten CMAS as in the prior art. The effectiveness of the CMAS protection material used in the first phase is thus preserved.

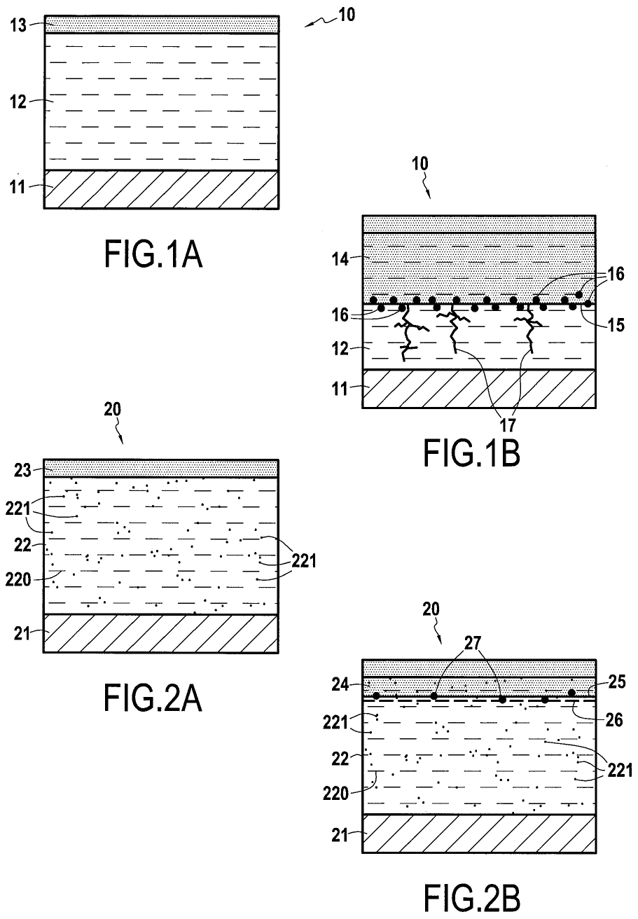

FIGS. 1A, 1B, 2A and 2B illustrate the effects produced by a calcium-magnesium-alumino-silicate CMAS protection layer according to the invention, namely a composite protective layer comprising the first and second phases described above, and a calcium-magnesium-alumino-silicate CMAS protection layer according to the prior art. More precisely, FIG. 1A shows a part 10 made of an AM1 nickel base superalloy substrate 11 and coated with a CMAS protection layer 12 according to the prior art made of Gd₂Zr₂O₇, the part being in the presence of CMAS 13 while FIG. 1B shows the part 10 when exposed to high temperatures that cause CMAS 13 to melt and infiltrate as CMAS liquid contaminants 14 into the protective layer 12.

FIG. 2A shows a part 20 consisting of a substrate 21 made of an AM1 nickel base superalloy and coated with a CMAS protection layer 22 according to the invention, the layer 22 comprising here a first phase 220 consisting of Gd₂Zr₂O₇ and a second phase 221 dispersed in the layer 22 and consisting of Gd₂Si₂O₇, the part being in the presence of CMAS 23 while FIG. 2B shows the part 20 when exposed to high temperatures that cause CMAS 23 to melt and infiltrate as CMAS liquid contaminants 24 into the protective layer 22.

In the case of a protective layer according to the prior art as shown in FIG. 1B, CMAS liquid contaminants 14 penetrate deeply into the protective layer 12 before forming a blocking apatite phase 15 while also forming in this area secondary phases 16 in significant quantities such as fluorites Zr(Gd,Ca)Oₓ which cause cracks 17 to appear in the underlying portion of the protective layer 12.

In a different way, in the case of a protective layer according to the invention as shown in FIG. 2B, the infiltration depth of CMAS liquid contaminants 24 into the protective layer 22 is limited by the rapid formation of blocking apatite phases 25 and 26 of type Ca₂Gd₈(SiO₄)₆O₂, which allows the liquid contaminants of CMAS 24 to be contained near the surface of the protective layer 24. In addition, if secondary phases 27 (such as fluorites Zr(Gd,Ca)Oₓ) appear in the apatite phases 25 and 26, these secondary phases are present in much smaller quantities than with the protective layer of the prior art and do not cause cracks to appear in the underlying portion of the protective layer 22.

The calcium-magnesium-alumino-silicates CMAS protection layer according to the invention has a thickness between 1 μm and 1000 μm and preferentially between 5 μm and 200 μm.

The substrate of the gas turbine engine part that is the subject matter of the invention can be made of a nickel or cobalt-based superalloy. In this case, the substrate may also have an alumino-forming bond coat on its surface. For example, the alumino-forming bond coat may include MCrAlY alloys (where M=Ni, Co, Ni and Co), nickel aluminides type β-NiAl (optionally modified by Pt, Hf, Zr, Y, Si or combinations of these elements), aluminides of alloys γ-Ni-γ′Ni₃Al (optionally modified by Pt, Cr, Hf, Zr, Y, Si or combinations of these elements), MAX phases (Mnₙ₊₁AXₙ (n=1,2,3) where M=Sc, Y, La, Mn, Re, W, Hf, Zr, Ti; A=groups IIIA, IVA, VA, VIA; X=C,N), or any other suitable bond coat, as well as mixtures thereof. The substrate can also consist of superalloys AM1, MC-NG, CMSX4 and derivatives, or René and derivatives.

Bond layers can be formed and deposited by physical vapour deposition (PVD), APS, HVOF, low-pressure plasma spraying (LPPS) or derivatives, inert plasma spraying (IPS), chemical vapour deposition (CVD), Snecma vapour-phase aluminizing (SVPA), spark plasma sintering, electrolytic deposition, as well as any other suitable deposition and forming process.

The substrate used in the invention has a shape corresponding to that of the gas turbine engine part to be made. Turbomachine parts including the protective layer according to the invention may be, but not exclusively, blades, nozzle vanes, high-pressure turbine rings and combustion chamber walls.

The composite calcium-magnesium-alumino-silicate protection layer, i.e. comprising the first and second phases as defined above, can be applied directly to the substrate of the gas turbine engine part. The protective layer of the invention constitutes in this case a thermal barrier for the substrate.

According to a variant embodiment, a thermal barrier layer may be interposed between the substrate and the composite protection layer of the invention, or between an alumino-forming bond coat and the composite protection layer of the invention, the latter being used in this case as a functionalization layer on the surface of the thermal barrier layer which may or may not provide protection against high-temperature liquid calcium-magnesium-alumino-silicate CMAS contaminants. By way of non-limiting example, the thermal barrier layer can be made of yttriated zirconia with a Y₂O₃ mass content of between 7% and 8%. The thermal barrier layer, on which the composite protection layer of the invention is made, may have a microstructure, homogeneous, homogeneous and porous, vertically microcracked, vertically microcracked and porous, columnar, columnar and porous, as well as architectures including these different microstructures.

The thermal barrier layer can be formed and deposited by electron beam-physical vapour deposition (EBPVD), APS, HVOF, solgel, SPS, solution precursor plasma spraying (SPPS), HVSFS or any other suitable process.

The composite protection layer of the invention may be formed and deposited by one of the following processes:
atmospheric plasma spraying (APS),
high-velocity oxygen fuel (HVOF),
suspension plasma spraying (SPS),
solution precursor plasma spraying (SPPS),
high-velocity suspension flame spraying (HVSFS), also known as suspension-HVOF (S-HVOF).

### EXAMPLE 1

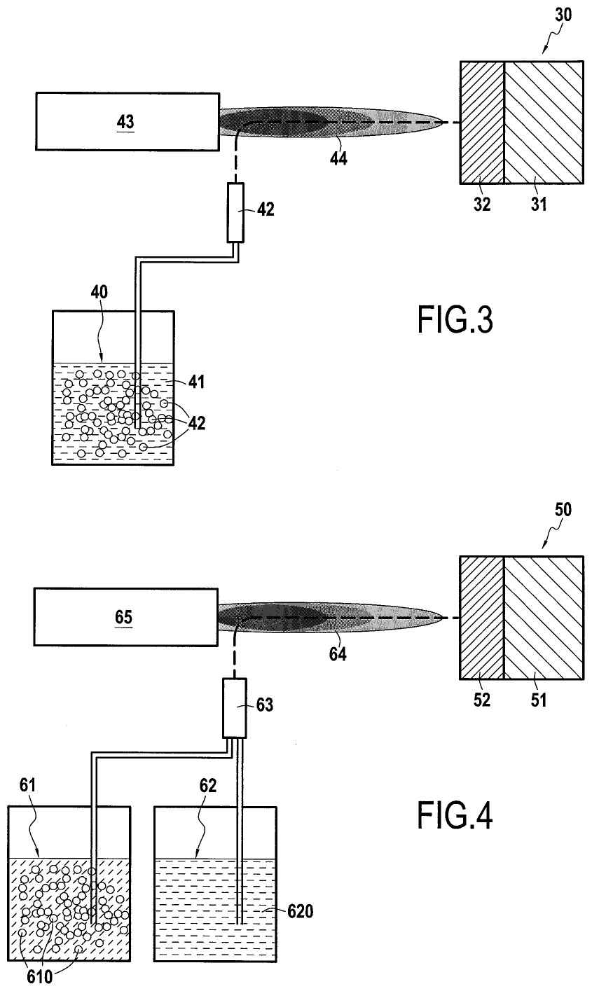

As shown in FIG. 3, a process for manufacturing a gas turbine engine part 30 in conformity with the invention was carried out on a substrate 31 made of AM1 nickel base superalloy on which a composite calcium-magnesium-alumino-silicate CMAS protection layer 32 was applied by SPS, the protective layer 32 comprising, according to the invention, a first phase of Gd₂Zr₂O₇ as calcium-magnesium-alumino-silicate CMAS protection material and a second phase of Y₂Si₂O₇ in the form of particles dispersed in the protective layer 32 as activating phase of protective apatite phases.

In this example, a solution 40 containing a powder of the anti-CMAS material in suspension 42, here Gd₂Zr₂O₇, and liquid precursors of the activating phase 41, here Y₂Si₂O₇, in volume proportions adapted for the realization of the protective layer 32 is used. The solution 40 is injected through the same suspension injector 42 into a plasma jet 44 generated by a plasma torch 43, allowing the thermokinetic treatment of the solution 40. In this example, the precursors of phase Y₂Si₂O₇ may be yttrium nitrate Y(NO₃)₃ and tetraethyl orthosilicate Si(OC₂H₅)₄ dissolved in ethanol. This results in a protective layer 32 comprising a first phase of Gd₂Zr₂O₇ as anti-CMAS material and forming the matrix of the layer 32 and a second phase of Y₂Si₂O₇ as activator of protective apatite phases in the form of particles finely dispersed in the matrix of the layer 32.

The example does not exclude the possibility of using other anti-CMAS materials or other silicate materials. The example also does not exclude the use of a precursor solution for the anti-CMAS phase and/or suspended powders for the silicate phase. It is also possible to produce the composite coating by using not a plasma torch but an HVOF device.

### EXAMPLE 2

As shown in FIG. 4, a process for manufacturing a gas turbine engine part 50 in conformity with the invention was carried out on a substrate 51 made of AM1 nickel base superalloy on which a composite calcium-magnesium-alumino-silicate CMAS protection layer 52 was applied by SPS, the protective layer 52 comprising, in accordance with the invention, a first phase of Gd₂Zr₂O₇ as calcium-magnesium-alumino silicate CMAS protection material and a second phase of Y₂Si₂O₇ in the form of particles dispersed in the protective layer 52 as activating phase for protective apatite phases.

In this example, a first solution 61 containing a powder of the anti-CMAS material in suspension 610, here Gd₂Zr₂O₇, and a second solution 62 containing liquid precursors of the activating phase 620, here Y₂Si₂O₇, in volume proportions adapted for the realization of the protective layer 52 are used. The two solutions 61 and 62 are injected through the same suspension injector 63 into a plasma jet 64 generated by a plasma torch 65, allowing the thermokinetic treatment of the solutions 61 and 62. In this example, the precursors of phase Y₂Si₂O₇ may be yttrium nitrate Y(NO₃)₃ and tetraethyl orthosilicate Si(OC₂H₅)₄ dissolved in ethanol. The example does not exclude the possibility of using other anti-CMAS materials or other silicate materials. This results in a protective layer 32 comprising a first phase of Gd₂Zr₂O₇ as anti-CMAS material and forming the matrix of the layer 32 and a second phase of Y₂Si₂O₇ as activator of protective apatite phases in the form of particles finely dispersed in the matrix of the layer 32.

The example also does not exclude the use of a precursor solution for the anti-CMAS phase and/or suspended powders for the silicate phase. It is also possible to produce the composite coating by using not a plasma torch but an HVOF device.

### EXAMPLE 3

As shown in FIG. 5, a process for manufacturing a gas turbine engine part 70 in conformity with the invention was carried out on a substrate 71 made of AM1 nickel base superalloy on which a composite calcium-magnesium-alumino-silicate CMAS protection layer 72 was applied by SPS, the protective layer 72 comprising, according to the invention, a first phase of Gd₂Zr₂O₇ as calcium-magnesium-alumino-silicate CMAS protection material and a second phase of Y₂Si₂O₇ in the form of particles dispersed in the protective layer 72 as activating phase of protective apatite phases.

In this example, a first solution 81 containing a powder of the anti-CMAS material in suspension 810, here Gd₂Zr₂O₇, and a second solution 82 containing liquid precursors of the activating phase 820, here Y₂Si₂O₇, in volume proportions adapted for the realization of the protective layer 72 are used. The solutions 81 and 82 are injected respectively through a first and a second specific suspension injectors 83 and 84 into the core of a plasma jet 85 generated by a plasma torch 86, allowing the thermokinetic treatment of the solutions 81 and 82. In this example, the precursors of phase Y₂Si₂O₇ may be yttrium nitrate Y(NO₃)₃ and tetraethyl orthosilicate Si(OC₂H₅)₄ dissolved in ethanol. This results in a protective layer 32 comprising a first phase of Gd₂Zr₂O₇ as anti-CMAS material and forming the matrix of the layer 32 and a second phase of Y₂Si₂O₇ as activator of protective apatite phases in the form of particles finely dispersed in the matrix of the layer 32.

The example does not exclude the possibility of using other anti-CMAS materials or other silicate materials. The example also does not exclude the use of a precursor solution for the anti-CMAS phase and/or suspended powders for the silicate phase. It is also possible to produce the composite coating by using not a plasma torch but an HVOF device.

### EXAMPLE 4

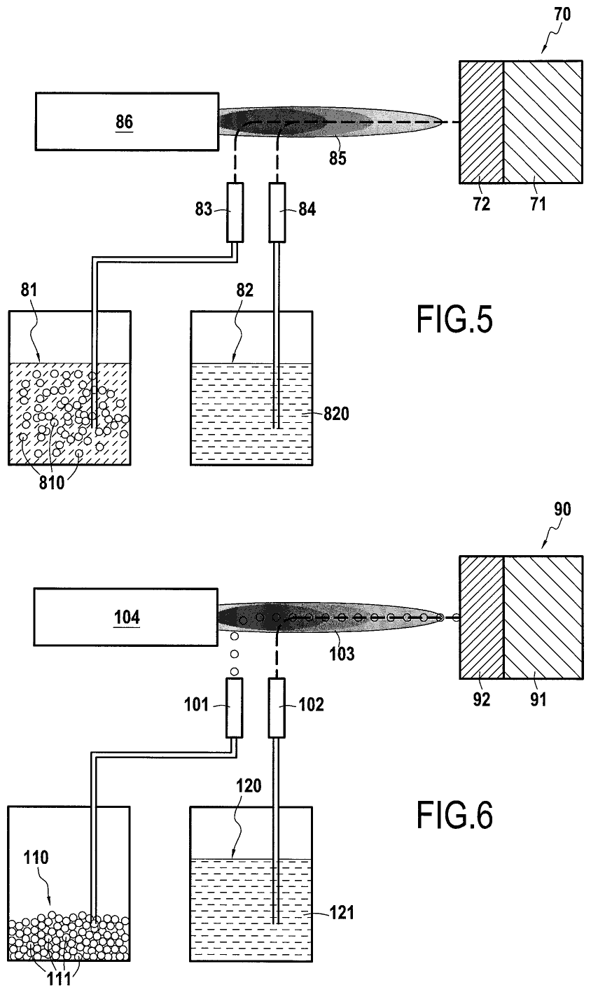

As shown in FIG. 6, a manufacturing process for a gas turbine engine part 90 conforming to the invention was carried out on a substrate 91 made of AM1 nickel base superalloy on which has been deposited a composite calcium-magnesium-alumino-silicate CMAS protection layer 92 by hybrid SPS and APS, the protective layer 92 comprising, in accordance with the invention, a first phase of Gd₂Zr₂O₇ as calcium-magnesium-alumino-silicate CMAS protection material and a second phase of Y₂Si₂O₇ in the form of particles dispersed in the protective layer 92 as activating phase for protective apatite phases.

In this example, a powder 110 composed of particles 111 of the anti-CMAS material, here Gd₂Zr₂O₇, and a solution 120 containing liquid precursors of the activating phase 121, here Y₂Si₂O₇, in volume proportions adapted for the realization of the protective layer 92 are used. For the powder 110, the APS process is used, whereby the powder 110 is injected through a first specific injector 101 into the core of a plasma jet 103 generated by a plasma torch 104, allowing the thermokinetic treatment of the powder 110. For the solution 120, the SPS process is used wherein the solution 120 is injected through a second specific suspension injector 102 into the core of the plasma jet 103 generated by a plasma torch 104, allowing the thermokinetic treatment of phase 121. In this example, the precursors of phase Y₂Si₂O₇ may be yttrium nitrate Y(NO₃)₃ and tetraethyl orthosilicate Si(OC₂H₅)₄ dissolved in ethanol. This results in a protective layer 32 comprising a first phase of Gd₂Zr₂O₇ as anti-CMAS material and forming the matrix of the layer 32 and a second phase of Y₂Si₂O₇ as activator of protective apatite phases in the form of particles finely dispersed in the matrix of the layer 32.

The example does not exclude the possibility of using other anti-CMAS materials or other silicate materials. The example also does not exclude the use of a precursor solution for the anti-CMAS phase and/or suspended powders for the silicate phase. It is also possible to produce the composite coating by using not a plasma torch but an HVOF device.

1. Coated gas turbine engine part comprising a substrate and at least one calcium-magnesium-alumino-silicate (CMAS) protection layer present on said substrate, the protective layer comprising a first phase of a calcium-magnesium-alumino-silicate (CMAS) protection material capable of forming an apatite or anorthite phase in the presence of calcium-magnesium-alumino-silicates (CMAS) and a second phase comprising particles of at least one rare-earth RP silicate dispersed in the first phase,
the calcium-magnesium-alumino-silicate (CMAS) protection material of the first phase capable of forming apatite or anorthite phases corresponding to one of the following materials or a mixture of several of the following materials: rare-earth zirconates RE^{b}₂Zr₂O₇, where RE^{b}=Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium), fully stabilized zirconia, delta phases A₄B₃O₁₂, where A=Y→Lu and B=Zr, Hf, composites Y₂O₃ with ZrO₂, yttrium and aluminium garnets (YAG), composites YSZ-Al₂O₃ or YSZ-Al₂O₃—TiO₂.

2. The part according to claim 1, wherein said at least one rare-earth silicate is a rare-earth monosilicate RE^{a}₂SiO₅ or a rare-earth disilicate RE^{a}₂Si₂O₇, wherein RE^{a} is selected from: Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutecium).

3. The part according to claim 1, wherein the rare-earth RE^{a} silicate particles dispersed in the calcium-magnesium-alumino-silicate (CMAS) protection layer have an average size between 5 nm and 50 μm.

4. The part according to claim 1, wherein the calcium-magnesium-alumino-silicate (CMAS) protection layer has a volume content of particles of said at least one rare-earth silicate between 1% and 80%.

5. The part according to claim 4, wherein the volume percentage of rare-earth RE^{a} silicate ceramic particles present in the calcium-magnesium-alumino-silicate (CMAS) protection layer varies in the direction of the thickness of the protective layer, the volume percentage of rare-earth RE^{a} silicate ceramic particles gradually increasing between a first zone of said layer adjacent to the substrate and a second zone of said layer remote from the first zone.

6. The part according to claim 1, wherein the calcium-magnesium-alumino-silicate (CMAS) protection layer has a thickness between 1 μm and 1000 μm.

7. The part according to claim 1, further comprising a thermal barrier layer interposed between the substrate and the calcium-magnesium-alumino-silicate (CMAS) protection layer.

8. The part according to claim 1, wherein the substrate is a nickel or cobalt-based superalloy and has on its surface an alumino-forming bond coat.

9. Process for manufacturing a gas turbine engine part according to claim 1, comprising at least one step of forming a calcium-magnesium-alumino-silicate (CMAS) protection layer directly on the substrate or on a thermal barrier layer present on the substrate, the forming step being performed with one of the following methods:
suspension plasma spraying from at least one suspension containing a powder or precursor of a calcium-magnesium-alumino-silicate (CMAS) protection material and a powder or precursor of a rare-earth RE silicate,
high-velocity flame spraying from at least one suspension containing a powder or precursor of a calcium-magnesium-alumino-silicate (CMAS) protection material and a powder or precursor of a rare-earth RE silicate,
atmospheric-pressure plasma spraying of a powder of a calcium magnesium alumino-silicate (CMAS) protection material in combination with suspension plasma spraying or high-velocity flame spraying from a solution containing a rare-earth RE silicate ceramic precursor or a rare-earth RE silicate ceramic powder in suspension.

10. The part according to claim 2, wherein the rare-earth RE^{a} silicate particles dispersed in the calcium-magnesium-alumino-silicate (CMAS) protection layer have an average size between 5 nm and 50 μm.
